(19) United States
(12) Patent Application Publication
(10) Pub. No.: US 2012/0329021 A1
(43) Pub. Date: Dec. 27, 2012

(54) Customizable Fitness System

(76) Inventor: Gary Wayne Hughes, Goshen, KY (US)

(21) Appl. No.: 13/167,854

(22) Filed: Jun. 24, 2011

(51) Int. Cl. G09B 19/00

(52) U.S. Cl. 434/257

(57) ABSTRACT

A workout system configured to increase the ease of determining a proper workout by any user and guiding said user through the workout safely. A series of color coded anatomical images displays muscles and muscle groups. The color coded anatomical images correlate directly to a plurality of body regions and provide guidance to muscles being used in each exercise. Photographs and descriptions accompany each exercise so said users may see how to perform the exercise correctly. Icons provide guidance regarding any equipment that may be used to perform the exercises and barcodes may be used to link the exercises to instructional videos. Besides being color coded, each exercise, body region, and muscles used are also labeled. The composite effect of these elements allow for workouts that can be developed by body region, muscles impacted, full body workout, or a random workout.

### BACKGROUND OF THE INVENTION

Obesity has become one of the major causes of illness and death in the United States nearing pandemic proportions. To combat obesity many people join gyms, hire trainers, purchase DVDs, watch TV programs, or purchase what often becomes useless equipment. For the most part, the aforementioned solutions can prove costly and would not be available for people with a limited income. Most failures in exercise programs are related to boredom due to people getting into a rut by following the exact same routine on a regular basis. Many expensive DVD exercise systems are often too strenuous for the average person and frustration, not fitness is the result. Also, most workout programs and systems are not usable in a gym environment while this system is designed for simplicity and portability.

Most people also do not know the impact of exercising on their bodies. Many misconceptions about how to exercise can often cause injuries. People are unaware of how muscles work or interact, the differences between strength training and aerobic exercises as they relate to fitness and weight loss, and what can help them achieve a specific goal. Certain equipment created over the years has proven to be ineffective and in some cases hinder the ability of the user to become fit.

### SPECIFICATIONS

My workout program is an easy-to-use color coded system that allows a user to exercise the entire body through a variety of means. Posterior and anterior anatomic illustrations divide the body into muscle groups (e.g. back, legs, chest, abs, shoulders, arms, etc.) via color codes and all exercises are color coded to correspond to a muscle group. The instruction illustrations also have each muscle labeled. Each exercise has a different color coded anatomic figure associated with it showing the exact muscles impacted. Labels accompany the color coding further describing the focused muscle group and the muscles impacted. The system also provides color photographs of an instructor performing each exercise accompanied by written guidelines and instructions to maximize impact and help prevent injury. Along with every exercise is a series of icons that provide a quick reference to possible equipment variations that can be used to perform the exercise (e.g. no equipment, bands, balls, chin-up bars, dumbbells, barbells, machines, etc.). A barcode may be included that will allow a user to access videos that provide additional exercise instructions.

### ADVANTAGES

The embodiment of my workout program allows for various routines that could focus on body parts, body region's, specific muscles, or offers the benefit of a full body workout. It provides the user instantaneous information about the muscles impacted and how to maximize the exercise while reducing injury. My workout program can be used by anyone regardless of age, sex, or physical ability. It also can be used by professional trainers or physical therapists to help people exercise or recover from injuries. My workout program can be focused and very specific or used for random routines. The color coding provides a quick reference process and the labeling will assist those who may be color vision impaired. My workout program can be used in a gym, at home, or in a hotel room as the icons illustrate ways to perform the exercises with no equipment, limited equipment or a full gym. Also, my workout program lends itself to any means of delivery from cards, books, smart phones, web sites, computer applications, or a combination thereof.

### DRAWING ABSTRACT

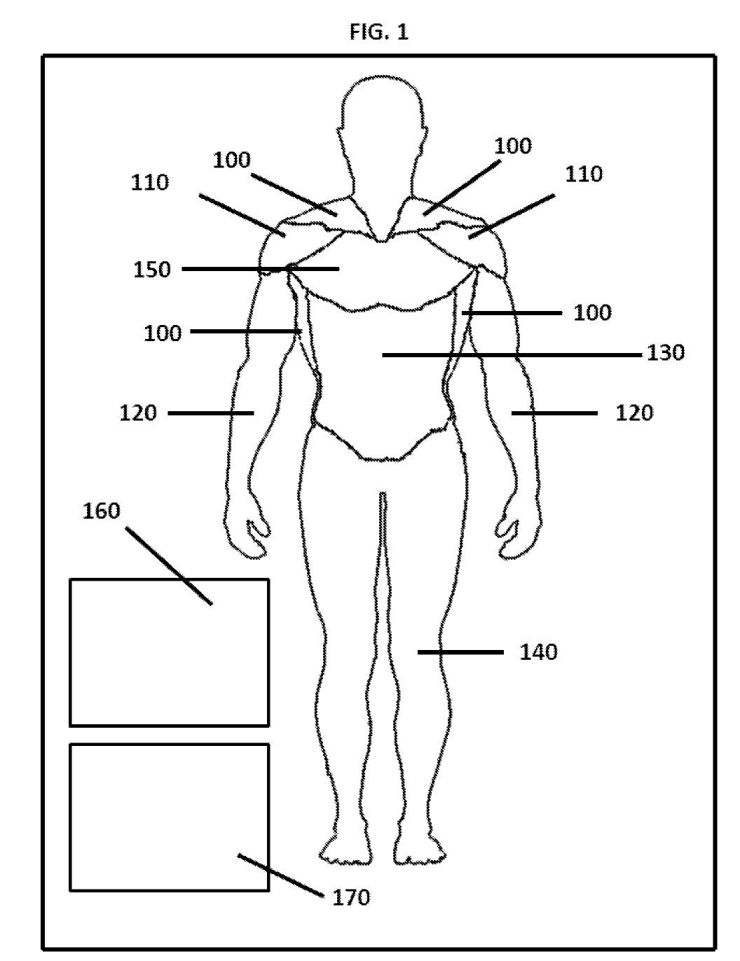

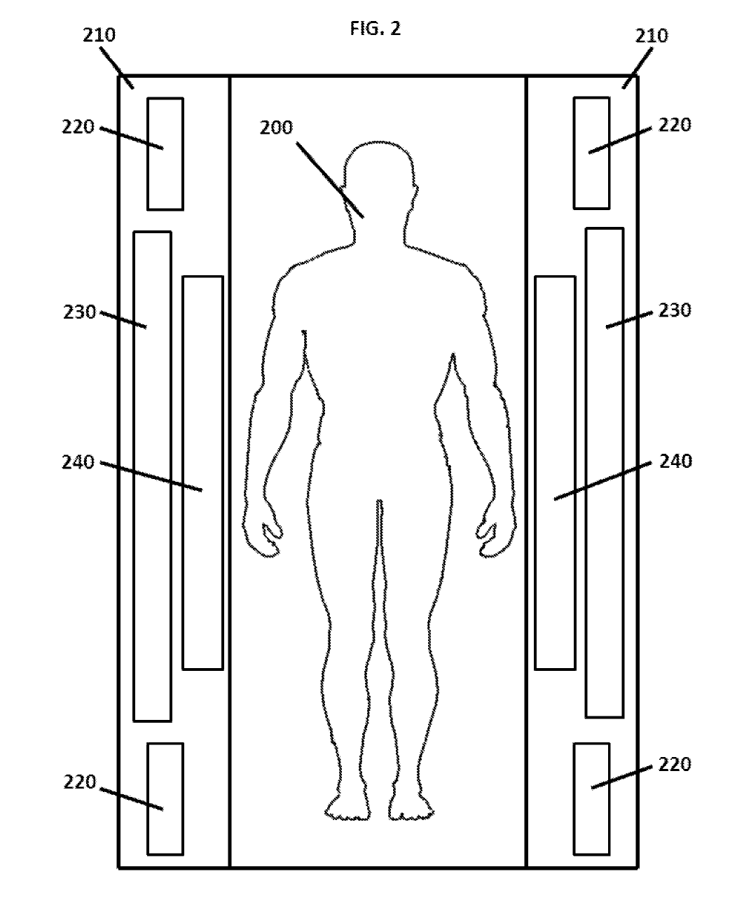

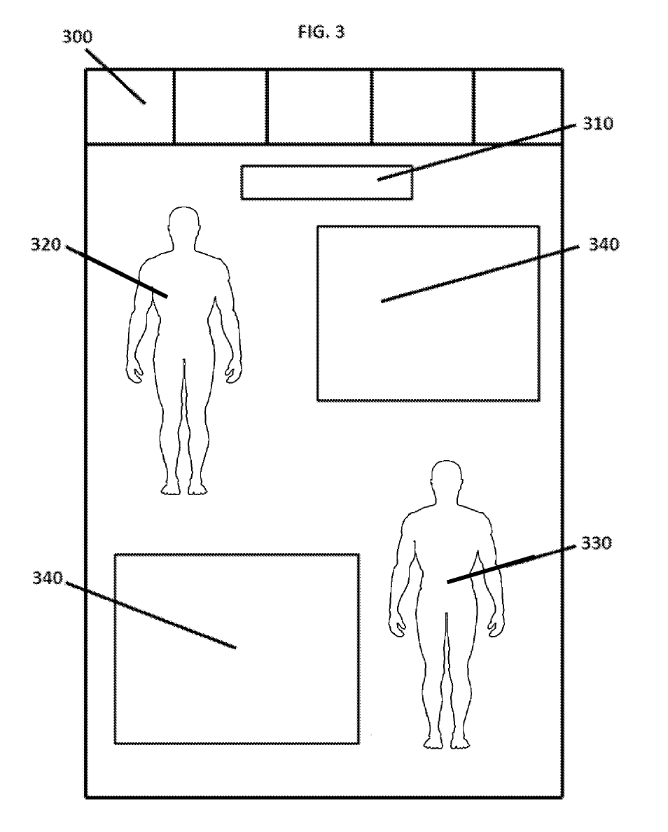

There is a plurality of color coded instructions contained in the embodiment with a single example illustrated by FIG. 1. In addition, there is a plurality of exercises contained within the embodiment with FIG. 2 and FIG. 3 representing how each would be illustrated and interrelated for a user.

### DRAWINGS—FIGURES

FIG. 1 represents the color coded instructions

FIG. 2 represents the color coded muscle specific diagram with color coded borders that correspond with the color codes depicted in FIG. 1.

FIG. 3 represents the exercise instruction with a color icon border on top that corresponds with the color codes depicted in FIG. 1 and FIG. 2.

### DETAILED DESCRIPTION—FIGS. 1, 2, AND 3

Referring to FIG. 1, consisting of a color coded anatomic image displayed from the posterior or anterior that includes a color for the back muscles 100, a second color for the shoulder muscles 110, a third color for the arm muscles 120, a fourth color for the abdominal and oblique muscles 130, a fifth color for the leg muscles 140, and a sixth color for the chest muscles 150. A space for color coded instructions 160 that correspond to the color coded primary muscles impacted in the anatomic figure of FIG. 2, 200 and a space for color coded instructions 170 that corresponds to the color coded secondary muscles impacted in the anatomic figure of FIG. 2,200. This image would also include labeling of the individual muscles of each group with arrows indicating each labeled muscle (not shown).

Referring to FIG. 2, a color coded muscle specific diagram that will be generated uniquely for each exercise contained in the embodiment yet corresponding to the instruction generated as represented by FIG. 3. An anatomic FIG. 200 may be displayed as either anterior or posterior and will have colors different from those in the anatomic figures used in FIG. 1. The colors in FIG. 200 will indicate the primary and secondary muscles impacted by the exercise performed in FIG. 3 and color coded as such to match the instructions of FIG. 1. Borders 210 will be color coded to match a specific color for a body region as mentioned in the descriptions of FIG. 1. Labels 220 will indicate the region for those who are color impaired while labels 230 will indicate the primary muscle(s) impacted and labels 240 will label the secondary muscles impacted. The colors of 220, 230, and 240 will be the same but vary substantially from the color of 210 for ease of reading.

Referring to FIG. 3, a color coded exercise instruction that will be generated uniquely for each exercise illustrated in the embodiment yet corresponding to the muscle specific diagram that will be represented by FIG. 2. A color coded icon border 300 will match the color of the borders of FIG. 2, 200 and correspond to the applicable body regions as color coded in FIG. 1. The icon border will also contain easily identifiable icons (not shown) representing the types of equipment, position, or difficulty that may be used to perform the exercise represented by FIG. 3. The name of the specific exercise will be located in the label 310. A photograph of the beginning of the exercise movement will be shown 320 along with a photograph of the end of the exercise 330, except where the exercise is a pose and does not require a beginning and an ending movement. In that case only photograph 320 will be shown. Instruction areas 340 may provide guidance for proper form, order of performance, or tips on how to prevent injury. Each exercise represented by a display of FIG. 3 will correspond directly to the impacted body areas and muscles as labeled and illustrated in FIG. 2. This image could also contain a barcode (not shown as the location will be dictated by space allowed by the images) that can link physical media (cards, books, posters, etc.) to digital media (smart phones, computer applications, web sites, etc.) that would provide additional guidance to the user.

### ADVANTAGES

From the description above, a number of advantages of some embodiments of my workout system become evident:
(a) A user can plan a workout based upon body regions by simply selecting multiple exercises with the same color borders or corner labels.
(b) A user can plan a workout based on specific muscles by either selecting exercises by primary and/or secondary muscle labels or by using the color coding on the exercise related anatomic figure that visually identifies specific muscles impacted.
(c) A user can plan a full body workout by selecting one exercise from each border color available (e.g. if there are six different border colors, one exercise from each color will provide a full body workout).
(d) A user can structure their workout by using specific equipment identified by the icons provided with each exercise.
(e) If a user does not have access to specific equipment they can remove the exercises that can only be done with that equipment without affecting the overall effectiveness of the embodiment.
(f) Professional fitness trainers, physical therapists or other qualified medical personnel can prescribe specific exercises related to illustrated muscles to help the user recover from injury or improve fitness.
(g) Users can improve the quality of their workouts by studying the photographs of the performed exercises and reading the recommended tips, order of performance and/or warnings.
(h) This embodiment allows the user to be any age or sex and have any level of physical ability.
(i) Workouts can be very structured, loosely structured, or random based upon the selection method chosen by the user.
(j) This embodiment allows a user to be able to exercise anywhere regardless of equipment availability.
(k) This embodiment allows a user to take advantage of multiple portable media to reinforce the practicality and usability of the system.

### CONCLUSIONS, RAMIFICATIONS, AND SCOPE

Accordingly, the reader will see that there are various workout programs available, but my embodiment offers benefits none of the others provide. It can be used by anyone; it can be focused on specific muscles, or muscle groups, or used to generate exercise routines at random. My embodiment also lends itself to use by professional trainers, physical therapists, or others in various sports or medical fields.

My exercise program also has the additional advantage that it can include multiple types of fitness activities (e.g. strength training, yoga, Pilates, cardiovascular training, etc.) with all of them equally interactive and interchangeable with the same base color codes, muscle groups, and muscle focus.

Although the description above contains many specificities, these should not be construed as limiting the scope of the embodiments but as merely providing illustrations of some of several embodiments.

Thus the scope of the embodiments should be determined by the appended claims and their legal equivalents, rather than by the examples given.

I claim:

1. A customizable workout system comprising:
(a) a plurality of color coded instructional anatomic figures with each color indicating a specific body region;
(b) a plurality of exercises with color coded labels to match said color coded instructional anatomic figures;
(c) a plurality of color coded muscle specific anatomic figures illustrating the muscles impacted by said exercises with a plurality of colors indicating the muscles impacted;
(d) a plurality of body region labels accompanying said color coded exercises verbally indicating the said body region impacted by said exercises;
(e) a plurality of muscle specific labels accompanying said color coded muscle specific anatomic figures verbally indicating the muscles impacted by said exercises;
(f) a plurality of images showing the performance of said exercises;
(g) a plurality of icons indicating exercise equipment needed to perform said exercises;
(h) a plurality of instructions accompanying said exercises;
(i) a plurality of barcodes that can link said exercises across various media.

2. The workout system of claim 1 wherein an exercise program can be customized by choosing any combination of said icons, said colors, said muscle groups, said muscles or said exercises.
